(19) United States
(12) Patent Application Publication
(10) Pub. No.: US 2024/0330669 A1
(43) Pub. Date: Oct. 3, 2024

(54) REINFORCED LEARNING APPROACH TO GENERATE TRAINING DATA

(71) Applicant: ADOBE INC., San Jose, CA (US)

(72) Inventors: Amir Pouran Ben Veyseh, Eugene, OR (US); Viet Dac Lai, Eugene, OR (US); Franck Dernoncourt, Spokane, WA (US)

(21) Appl. No.: 18/116,129

(22) Filed: Mar. 1, 2023

(51) Int. Cl. G06N 3/08; G06N 3/0475

(52) U.S. Cl. CPC G06N 3/08; G06N 3/0475

(57) ABSTRACT

In various examples, reinforcement learning techniques are used during joint training of a generative model with at least one other model. For example, a first set of training data and a second set of training data generated by the generative model are combined and used to train an event detection model. In addition, in such examples, a reward is determined based on the performance of the event detection model (e.g., an agreement between gradients of a loss function of training data and synthetic data) and used at least in part to update the parameters of the generative model.

### BACKGROUND

Various types of artificial intelligence (AI) models can be trained using various training techniques. For example, a machine learning model can be trained to perform event detection tasks such as identifying mentions of events (e.g., marriage, transport, transaction, etc.) in text. In addition, event detection systems benefit various downstream applications such as knowledge base construction and question answering. However, the high cost of annotating data, data scarcity, and lack of specialized training data are challenges to training and deploying effective event detection systems.

### SUMMARY

Embodiments described herein are directed to generating labeled training data to train a machine learning model to perform event detection tasks. Advantageously, in various embodiments, the systems and methods described are directed towards a machine learning model (e.g., a generative model) that is trained to generate training data for training an event detection model or other components of an event detection system. In particular, reinforced learning techniques can be used to improve the result of the generative model by updating the parameters of the generative model based on performance of an event detection model trained using training data generated by the generative model. For example, the performance of the event detection model is evaluated and reward values based on the evaluation are used to update the parameters of the generative model.

The systems and methods described are capable of generating labeled training data, using the generative model, which addresses data scarcity issues and improves the performance of event detection models. In one example, a pre-trained generative model is fine-tuned or otherwise modified as part of the training process of the event detection model using reinforced learning techniques. In this example, the interaction between the event detection model and the generative model can eliminate the need for noise filtering/canceling during the training process. Furthermore, in various embodiments, this training process iteratively evaluates the results of the event detection model and utilizes this feedback to improve the labeled data generated by the generative model. For example, parameters of the generative model are treated as meta-parameters to be optimized along with the parameters of the event detection model. In various embodiments, this enables domain specific training of the event detection model despite data scarcity for the specific domain. In an example, in the domain of scientific papers, the amount of labeled training data is insufficient to train an effective event detection model, the generative model is then trained, using techniques described in the present disclosure, to generate labeled training data that matches the domain of scientific papers.

During training of the event detection model, in an embodiment, an initial set of training data (e.g., human annotated and/or labeled data) is used to pre-train the event detection model and/or the generative model, then a set of synthetic training data (e.g., annotated and/or labeled data generated by the generative model) is combined with the initial set of training data, the combined set of training data is then used to train the event detection model and the performance of the trained event detection model is used to modify the parameters of the generative model. Furthermore, in such embodiments, as the parameters of the generative model are modified, additional synthetic training data is generated and combined with the training data and the training process is iteratively repeated. In addition, in various embodiments, the parameters of the generative model are updated based on a reward calculated from the results of the event detection model (e.g., detection of events in a development dataset). In such embodiments, the reward causes the parameters of the generative model to be modified in order to generate synthetic data that decreases a loss value associated with the event detection model.

### BRIEF DESCRIPTION OF THE DRAWINGS

The present invention is described in detail below with reference to the attached drawing figures, wherein:

FIG. 1 depicts an environment in which one or more embodiments of the present disclosure can be practiced.

FIG. 2 depicts an environment in which reinforcement learning is used to training a generative model, in accordance with at least one embodiment.

FIG. 3 depicts an example process flow for training a generative model using reinforcement learning, in accordance with at least one embodiment.

FIG. 4 depicts an example process flow for terminating training of a generative model, in accordance with at least one embodiment.

FIG. 5 depicts an example process flow for fine-tuning a generative model, in accordance with at least one embodiment.

FIG. 6 is a block diagram of an exemplary computing environment suitable for use in implementations of the present disclosure.

### DETAILED DESCRIPTION

Embodiments described herein generally relate to training a generative model using reinforcement learning techniques in parallel with training an event detection model. In accordance with some aspects, the systems and methods described are directed to determining performance metrics associated with the event detection model trained, at least in part, using training data generated by the generative model and updating the parameters of the generative model based on the performance metrics. For example, the system and methods described in the present disclosure iteratively generate synthetic data (e.g., labeled and/or annotated data generated by the generative model), train the event detection model using a combination of synthetic data and training data (e.g., ground truth labeled and/or annotated data), evaluate the performance of the event detection model on development data (e.g., an agreement between gradients of a loss function of training data and synthetic data) and then update the parameters of the generative model based on a result of evaluating the performance of the event detection model.

In various embodiments, the generative model and/or the event detection model are pre-trained using a training data set. For example, the generative model is pre-trained using the training dataset (e.g., human labeled ground truth data) in order to create synthetic data that is similar to the training dataset prior to generating data used to train the event detection model. In other examples, pre-training the generative model includes augmenting the training data with one or more labels to indicate trigger words (e.g., words that indicated an event) for the event detection model. Once the generative model is pre-trained, in various embodiments, during a training iteration, the generative model generates a batch of synthetic data (e.g., new labeled training data).

In such embodiments, the synthetic data is combined with the training data to serve as training data sampled from the training dataset and used to update the parameters of the event detection model (e.g., train the event detection model). In turn, the parameters of the generative model, in various embodiments, are updated using reward values determined based on an average of a loss (e.g., loss function) over the development data. In an embodiment, the reward values indicate the performance of the event detection model to perform event detection tasks using the development data and is calculated such that the loss value associated with training the event detection model is reduced. For example, the results of the event detection model are compared to the labels (e.g., ground truth) of the combined sampled training data and the synthetic data to compute the gradient of the loss function which is used to update the parameters of the event detection model based on the agreement of the gradient of the loss function over the development data.

Other solutions rely on the training data to train the generative model. In one example, the generative model is trained using the training data set without any additional training and/or tuning. However, due to data sacristy issues, the size of the training and development data for training the event detection model is limited, causing high variance and less reliable estimation for the performance improvement reward, precluding the fine-tuning of the generative model. Furthermore, yet other solutions perform fine-tuning of the generative model separately from training of the event detection model. This can lead to sub-optimal results of the event detection model based on synthetic data generated by the generative model that is noisy and/or redundant. In addition, such solutions necessitate noise filtering and/or canceling procedures during training.

Aspects of the technology described herein provide a number of improvements over existing technologies. For instance, various embodiments described in the present disclosure compute the reward for reinforcement learning for training based on an agreement between the gradient of a loss function computed based on the generated samples and the gradient computed of the loss function (e.g., cosine similarity) based the development data. In this manner, the generative model will generate labeled data (e.g., synthetic training data) that aligns with a direction that decreases the loss associated with the event detection model when processing the development data, thereby improving performance of the event detection model in accordance with various embodiments. For example, since the reward does not rely directly on the performance of the event detection model using the development set, the resulting generative model generates robust training data to enhance the quality of the generated data for training the event detection model.

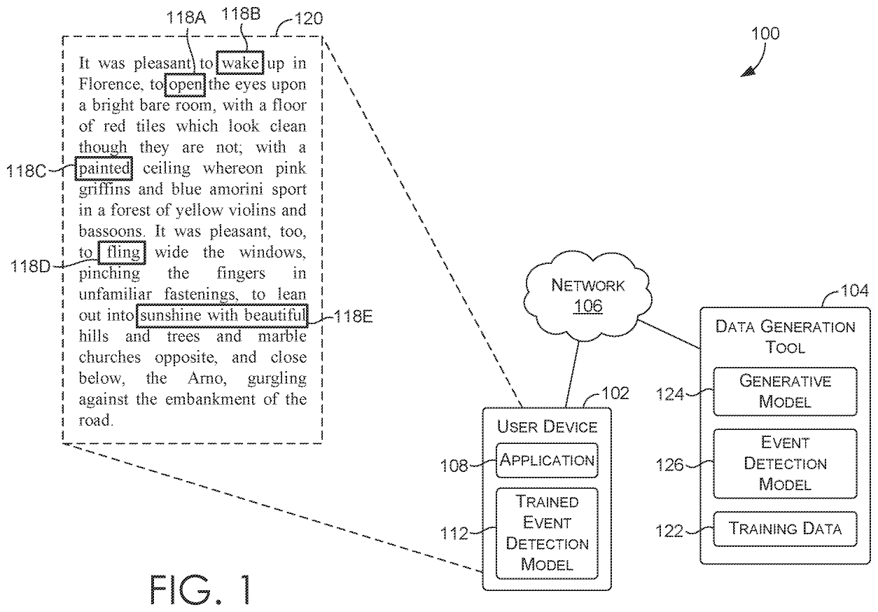

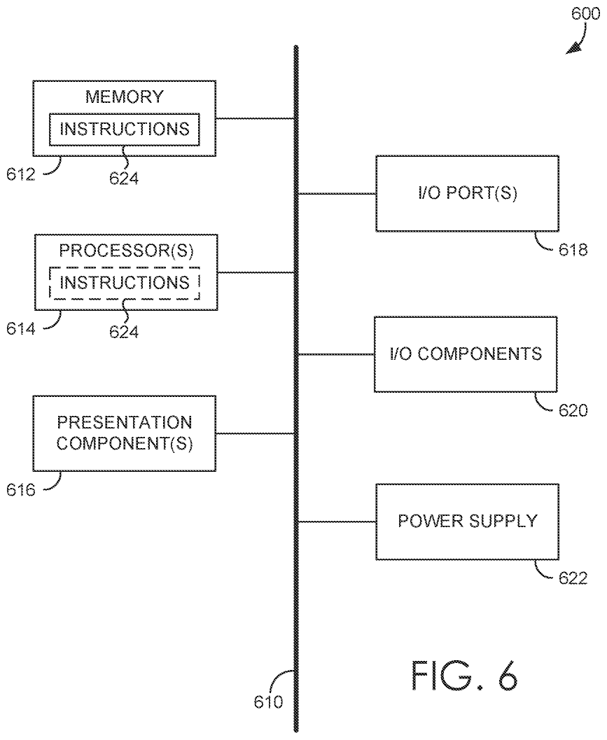

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 6.

It should be understood that operating environment 100 shown in FIG. 1 is an example of one suitable operating environment. Among other components not shown, operating environment 100 includes a user device 102, a data generation tool 104, and a network 106. Each of the components shown in FIG. 1 can be implemented via any type of computing device, such as one or more computing devices 600 described in connection with FIG. 6, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the data generation tool 104 includes multiple server computer systems cooperating in a distributed environment to perform the operations described in the present disclosure.

User device 102 can be any type of computing device capable of being operated by an entity (e.g., individual or organization) and obtains data from the data generation tool 104 and/or a data store which can be facilitated by the data generation tool 104 (e.g., a server operating as a frontend for the data store). The user device 102, in various embodiments, has access to or otherwise maintains a trained event detection model 112. For example, the application 108 includes an information extraction system, question answering system, or other application that uses the trained event detection model 112 to detect events (e.g., trigger words) 118A-118E. In the example illustrated in FIG. 1, the trained event detection model 112 detects the events 118A-118E within text 120 including a set of sequences of words (e.g., sentences). Although the trained event detection model 112 as illustrated in FIG. 1 detected events 118A-118E within the text 120, other types of inputs and event detection models can be used in accordance with the embodiments described in the preset disclosure. For example, the trained event detection model 112 can detect events within audio, video, images, or other data.

In some implementations, user device 102 is the type of computing device described in connection with FIG. 6. By way of example and not limitation, the user device 102 can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice.

In various embodiments, the application 108 includes any application capable of facilitating the exchange of information between the user device 102 and the data generation tool 104. For example, the application 108 can provide performance information associated with the trained event detection model 112 to the data generation tool 104. In some implementations, the application 108 comprises a web application, which can run in a web browser, and can be hosted at least partially on the server-side of the operating environment 100. In addition, or instead, the application 108 can comprise a dedicated application, such as an application being supported by the user device 102 and the data generation tool 104. In some cases, the application 108 is integrated into the operating system (e.g., as a service). It is therefore contemplated herein that “application” be interpreted broadly. Some example applications include ADOBE® SIGN, a cloud-based e-signature service, and ADOBE ACROBAT®, which allows users to view, create, manipulate, print, and manage documents.

For cloud-based implementations, for example, the application 108 is utilized to interface with the functionality implemented by the data generation tool 104. In some embodiments, the components, or portions thereof, of the data generation tool 104 are implemented on the user device 102 or other systems or devices. Thus, it should be appreciated that the data generation tool 104, in some embodiments, is provided via multiple devices arranged in a distributed environment that collectively provide the functionality described herein. Additionally, other components not shown can also be included within the distributed environment.

As illustrated in FIG. 1, the data generation tool 104 includes a generative model 124, and event detection model 126, and training data 122. In various embodiments, the generative model 124 includes a machine learning model that generates synthetic data used to train the event detection model 126 (e.g., in addition to or as a replacement to the training data 122). In one example, the generative model 124 includes a Generative Pre-trained Transformer 2 (GPT-2) model. In other embodiments, the generative model 124 includes any model capable of generating data such as text, images, video, audio, or other information that can be used to train a machine learning model such as the event detection model 126.

In various embodiments, the event detection model 126 is trained (e.g., the trained event detection model 112) to detect event triggers and generate annotation indicating detected event triggers. For example, given an input sequence (e.g., a sentence, words, images, audio, video, etc.) S=[w₁, w₂, . . . , wₙ], the objective of the event detection task is to predict the label sequence Y=[y₁, y₂, . . . , yₙ] in which yᵢ∈{B_EventType, I_EventType, 0} (e.g., beginning, inside, outside (BIO) annotating format) is the label for i-th word and EventType is one of the types in the event ontology (e.g., the types of events the event detection model 126 is trained to detect). In this example, B_EventType indicates the object (e.g., word) of the detected event, I_EventType indicates additional objects of the detected event, and 0 indicates the object is not associated with the detected event. In the example illustrated in FIG. 1, for the detected events 118A-118E, the trigger words would be assigned and/or annotated with B_EventType or I_EventType based on the location in the sentence (e.g., “sunshine” in event trigger 118E is annotated with the B_EventType and “with beautiful” are both annotated with the I_EventType) and all other words are assigned and/or annotated with 0. Although the BIO annotating format is used in the examples described above, other annotation formats and/or techniques can be used in accordance with various embodiments described in the present disclosure.

In various embodiments, the objective and/or task of the event detection model 126 and/or trained event detection model 112 is to predict the label of a given object in a sequence. For example, the object of the event detection model 126 predict a set of labels for a set of words in a sentence included in the training data 122, where the training data includes ground truth annotated data (e.g., sentences). In an embodiment, given the sentence S=[w₁, w₂, . . . , wₙ] and the index t for the words of the sentence wₜ∈S, the objective and/or task of the event detection model 126 is to predict the event type (e.g., denoted by Y) that is evoked by wₜ. In various embodiments, an event type None is added to the event ontology to indicate that wₜ is not a trigger word (e.g., not a detected event 188A-118E).

In an embodiment, the event detection model 126 includes a Bidirectional Encoder Representations from Transformers (BERT) model to perform event detection tasks. In various examples, the event detection model 126 is represented as M_{θ} where θ indicates the set of parameters of the event detection model 126 M_{θ}. In an embodiment, event detection model 126 M_{θ} is trained over a number of iterations (e.g., epochs), where a training iteration uses a sample and/or batch of training data obtained from that training data 122 (e.g., a labeled dataset [symbol] _{O}) and a sample and/or batch of synthetic data [symbol] generated by the generative model 124, where the generative model 124 is represented by M_{ψ} with [symbol] _{ψ} representing the parameters of the generative model 124 M_{ψ}.

Once the event detection model 126 M_{θ} is trained and/or optimizing (e.g., during a particular iteration) using the combined batch of training data (e.g., [symbol] =∪ [symbol] ), in an embodiment, the performance of the event detection model 126 Mₑ on a sample and/or batch of development data [symbol] is used to compute or otherwise generate signals to update the parameters of the generative model 124 M in a reinforcement learning (RL) framework. In one example, the signals include reward values (e.g., values computed per generated sample) that are used to modify the parameters ψ of the generative model 124 M_{ψ} using a reinforcement learning algorithm (e.g., the REINFORCE algorithm).

In various embodiments, one or more pre-training tasks are used to prepare the generative model 124 to generate labeled synthetic data [symbol] _{G} used to train the event detection model 126. In one example, the generative model 124 is pre-trained to include labels (e.g., <TRG> and </TRG>) which indicate the event within the synthetic data [symbol] _{G}. Furthermore, in such an example, the pre-training task trains the generative model 124 to place these labels around the events (e.g., trigger words) within the synthetic data [symbol] _{G}. In various embodiments, the training data 122 is used to pre-train the generative model 124. In such embodiments, the training data 122 is modified to include the label-augmented training data (e.g., labels are added to the training data for the pre-training tasks). For example, for a sentence S=w₁, w₂, . . . , wₙ in the original training data 122 represented as [symbol] , a label-augmented training data is generated by at least including special labels (e.g., <TRG> and </TRG>) to mark the positions of the event triggers in S. In this example, to specify wₜ∈S as a trigger word, the label-augmented training data (e.g., S′=w₁, w₂, . . . , <TRG>wₜ<TRG>, . . . , wₙ, where S′ represents the label-augmented training data) is generated. In various embodiments, a pre-trained generative model 124 is fine-tuned using the label-augmented training data S′ using an auto-regressive algorithm (e.g., the generative model 124 is tasked with predicting the current token in S′ given previous tokens).

As a result of this fine-tuning process, in various embodiments, the generative model 124 M_{ψ} generates new label-augmented training data (e.g., sentences included in [symbol] _{G}) which is used to train the event detection model 126. In addition, in an embodiment, event types are not indicated in the marking in label-augmented training data S′ to simplify the generation task for generative model 124. However, in other embodiments, the pre-training task for the generative model 124 can include event type information in order to cause the generative model 124 to generate synthetic data including event type information. Returning to the embodiment above, computing the probability distribution P(⋅|S, i) and the loss function [symbol] _{B} for the synthetic data generated by the generative model 124, a two-layer feed-forward network FF_{G} with the probabilities for two classes (e.g., Event and Non-Event) as the outputs is used. For example, the event identification task in synthetic data and event detection task in training data 122 are trained jointly with the shared encoder and different classification heads.

In various embodiments, as a result of the pre-training task, the generative model 124 generates in-domain labeled synthetic data. For example, the training data 122 includes annotated scientific papers (e.g., the domain) and the generative model 124, after pre-training, is capable of producing labeled synthetic data within the domain of scientific papers. In addition, in various embodiments, to further improve the synthetic data generated by the generative model 124, feedback during training of the event detection model 126 is used to modify the parameters ψ of the generative model 124 M_{ψ}.

In various embodiments, during the training of the event detection model 126 M_{θ}, the parameters ψ of the generative model 124 are treated as meta-parameters to be optimized based on the performance of the event detection model 126 on a development training data (e.g., a sample of the training data 122). For example, the performance of the event detection model 126 M_{θ} on the development training data [symbol] (e.g., measured by F1 scores and/or loss function values) is used as the reward for the synthetic data [symbol] generated by the generative model 124 to update MP with reinforcement learning. In various embodiments, the reward for the generated data [symbol] is computed or otherwise determined based on an agreement between gradients of a loss function of the event detection model 126 based on the development training data [symbol] and the synthetic data [symbol] In such embodiments, the parameters ψ of the generative model 124 M_{ψ} are updated to reduce the loss values generated by the event detection model 126 on the development training data [symbol] and thereby produce improved synthetic data for training the event detection model 126. The reinforcement learning technique for training the event detection model 124 and the generative model 126 in parallel is illustrated by the following pseudo-code:

```
RL Training Algorithm
Input: [symbol]  , [symbol]
Output: Models M_{ψ} and M_{θ}
Initialize θ₀ and ψ₀
For t = 1 to num_train_steps do
  Sample | [symbol]   | data points from [symbol]
  Generate | [symbol]   | data points from Sₖ, Yₖ using generative mode with
  S′ₖ as the label-augmented text
  Sample | [symbol]   | data points from [symbol] [symbol]
  ← [symbol]   ∪ [symbol] [symbol]
  Optimize θ
  ${g}_{θ} ← \frac{1}{\vert {ℬ}_{𝒞} \vert} {\sum }_{( S , Y ) ∈ {ℬ}_{𝒞}} {∇}_{θ} {ℒ}_{B} ( S , Y ; {θ}_{t - 1} )$
  θₜ ← GradientUpdate(θₜ₋₁, g_{θ}) [symbol]
  Evaluate M on [symbol]
  ${d}_{θ} ← \frac{1}{\vert {ℬ}_{𝒟} \vert} {\sum }_{( S , Y ) ∈ {ℬ}_{𝒟}} {∇}_{θ} {ℒ}_{B} ( S , Y ; {θ}_{t} )$ [symbol]
  Optimize ψ
  rₖ ← d_{θ}^{T} · ∇_{θ} [symbol]   (Sₖ, Yₖ; θₜ₋₁)
  ${d}_{ψ} ← \frac{1}{\vert {ℬ}_{𝒢} \vert} {\sum }_{k = 1}^{\vert {ℬ}_{𝒢} \vert} {r}_{k} \cdot {∇}_{ψ} log P ( {S}_{k}^{′} ; {ψ}_{t - 1} )$
  ψₜ ← GradientUpdate(ψₜ₋₁, d_{ψ})
end
```

As illustrated in the pseudo-code above, updates to the event detection model 126 M_{θ} and generative model 124 M_{ψ} are performed at batch level for a number of iterations (e.g., num_train_steps). In various embodiments, for training interval t, one batch of training data [symbol] _{O} and one batch of development data [symbol] are sampled from the training data 122 [symbol] . In other embodiments, the development data [symbol] is sampled from a different dataset. In addition, a batch of synthetic data [symbol] is also generated by the generative model 124 for training interval t in various embodiments. For example, for a batch synthetic data [symbol] , Sₖ represents a sequence (e.g., a sentence), Yₖ represents a set of labels in the BIO label format corresponding to elements of the sequence, and S′ₖ represents the sequence Sₖ augmented with the labels (e.g., <TRG> and </TRG>) indicating the event trigger, where k represents a particular sequence within the batch of synthetic data [symbol] .

In various embodiments, to train the event detection model 126 M_{θ}, the training data 122 batch [symbol] and the synthetic data batch [symbol] are combined to form an augmented training batch [symbol] . The event detection model 126 M_{θ}, in an embodiment, is then updated using the gradient of the loss function [symbol] _{B} over [symbol] , leading to the new parameters θₜ for M_{θ}. Training the event detection model 126 is illustrated by the following equation:

$${g}_{θ} ← \frac{1}{\vert {ℬ}_{𝒞} \vert} {\sum }_{( S , Y ) ∈ {ℬ}_{𝒞}} {▽}_{θ} {ℒ}_{B} ( S , Y ; {θ}_{t - 1} ) ,$$

where the gradient of the loss function [symbol] is computed based on the parameters of the previous iteration t−1 and the labels Y generated by the event detection model 126. In various embodiments, the gradient and the parameters from the previous iteration θₜ₋₁ are used to generate the current parameters Bt. In an embodiment, event types are not included in the synthetic data [symbol] (e.g., not generated by the generative model 124) and, as a result, the probability and the loss function [symbol] _{B} for [symbol] are computed with a different classification head for the feed forward network FF_{G} from those for [symbol] (e.g., FF_{O}).

Once the current parameter θₜ for the event detection model 126 are updated or otherwise generated, the reward for the generated batch of synthetic data [symbol] obtained from generative model 124 is computed. For example, the current parameters θₜ for the event detection model 126 M_{θ} are evaluated by computing the average loss [symbol] over the development data [symbol] represented by the following equation:

$${d}_{θ} ← \frac{1}{\vert {ℬ}_{𝒟} \vert} {\sum }_{( S , Y ) ∈ {ℬ}_{𝒟}} {▽}_{θ} {ℒ}_{B} ( S , Y ; {θ}_{t} ) .$$

In an embodiment, d_{θ} indicates the performance of the event detection model 126 to detect events within the development data [symbol] . Furthermore, in various embodiments, the gradient of the loss function [symbol] (e.g., with respect to the current parameters θₜ of event detection model 126 M_{θ}) represents a direction that causes a reduction of the loss of the event detection model 126 over development data [symbol] . For example, the reward for a generated sample (Sₖ, Yₖ)= [symbol] is measured by the similarity and/or agreement between the gradient of [symbol] derived by (Sₖ, Yₖ) and the steepest direction d_{θ} of the event detection model 126 (e.g., for the current iteration) over the batch of development data [symbol] .

In an embodiment, the reward for a particular generated sequence (Sₖ, Yₖ) is computed as rₖ=d_{θ}^{T}·∇_{θ} [symbol] (Sₖ, Yₖ; θₜ₋₁), where the dot product of the gradient of the loss function and the transpose of d_{θ} is computed. As described above, in various embodiments, the reward value is used to update the parameters ψ for generative model 124 using the rewards rₖ, thereby causing the generative model 124 to generate appropriate data for the event detection model 126 in the next iteration of the algorithm. For example, the gradient of the reward used to update the generative model 124 M_{ψ} can be estimated based on the synthetic data

$${ℬ}_{𝒢} : {d}_{ψ} = \frac{1}{\vert {ℬ}_{𝒢} \vert} {\sum }_{k = 1}^{\vert {ℬ}_{𝒢} \vert} {r}_{k} \cdot {▽}_{ψ} log P ( {S}_{k}^{′} ; {ψ}_{t - 1} )$$

where S′ₖ is the sequence with the augmented labels corresponding to the sequence Sₖ, Yₖ∈ [symbol] . In various embodiments, the updated generative model 124 M_{θ} is then used to generate additional synthetic data in the next iteration of the algorithm.

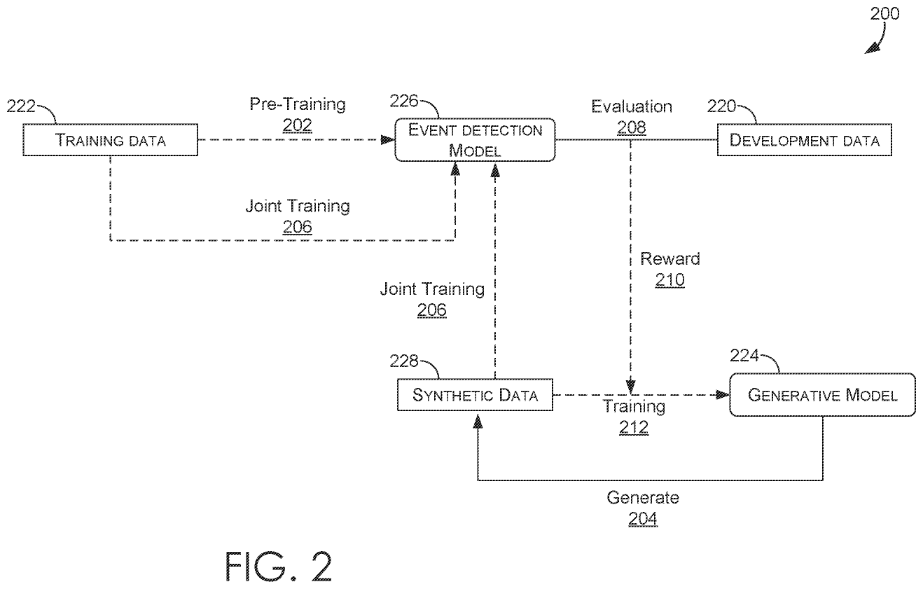

FIG. 2 depicts an environment 200 in which a generative model 224 and an event detection model 226 are trained using joint training 206 (e.g., trained in parallel) in accordance with an embodiment. As described above, in various embodiments, reinforcement learning techniques are used to generate a reward 210 based on an evaluation 208 on the event detection model 226. For example, the reward 210 is used to update the parameters of the generative model 224. Furthermore, in an embodiment, the evaluation of the event detection model 226 is performed using development data 220. For example, the event detection model 226 can perform inferencing on the development data 220 and the results are compared (e.g., using a loss function) to annotation (e.g., ground truth) associated with the development data 220.

In various embodiments, pre-training 202 is performed using the event detection model 226 prior to joint training with the generative model 224. For example, the event detection model 226 can be pre-trained using the training data 222 or a portion of the training data 222. Other pre-training tasks can be performed in accordance with various embodiments. For example, the generative model 224 is pre-trained using the training data 222 to generate 204 synthetic data 228. Furthermore, during joint training 206, in an embodiment, the synthetic data 228 is used to train the event detection model 226. For example, the synthetic data 228 is combined with a sample (e.g., portion) of the training data 222 to generating training data used to train the event detection model 226.

In an embodiment, the joint training 206 is performed iteratively and the performance of the resulting event detection model 226 is determined and used to compute the reward 210. For example, the reward 210 is used in training 212 the generative model 224. Once the generative model 224 is trained during the training 212, in various embodiments, the iterative process is repeated and additional synthetic data 228 is generated 204 to be used during joint training 206 of the event detection model 226. In an embodiment, values can be used as seeds to the generative model 224 to generate 204 the synthetic data 228. In addition, the synthetic data 228, in an embodiment, includes labeled data that simulates the training data 222. For example, the synthetic data 228 includes textual data including labels indicating event triggers. Although the event detection model 226 is described in connection with the reinforcement learning techniques described in connection with FIG. 2, in other embodiments, alternative machine learning models are used. For example, any machine learning model that is trained using data to perform inferencing tasks can be used in connection with the embodiments described, such as an object detection model, information extraction, recognition models, or other models.

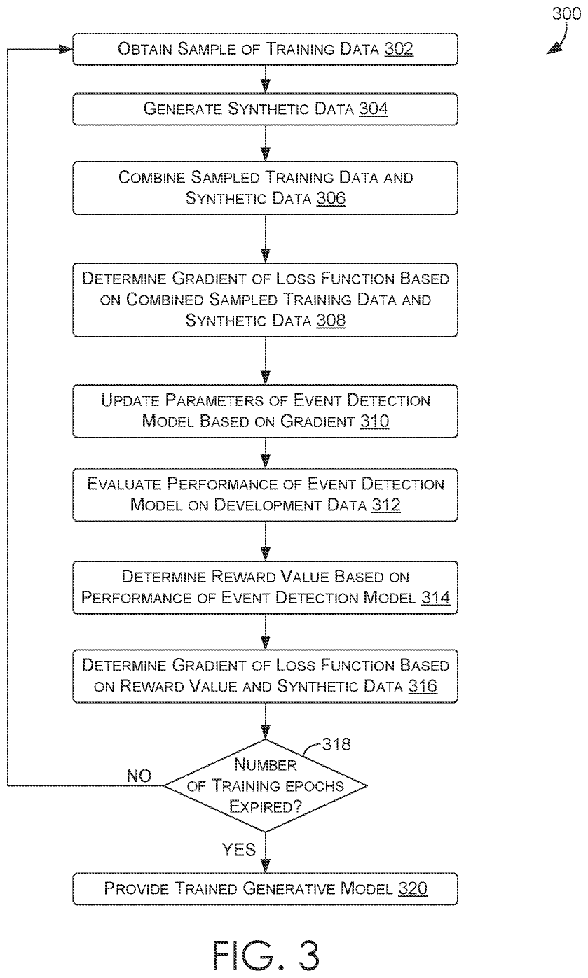

FIG. 3 is a flow diagram showing a method 300 for reinforcement learning of a generative model based on performance of an event detection model in accordance with at least one embodiment. The method 300 can be performed, for instance, by the data generation tool 104 of FIG. 1. Each block of the method 300 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 302, the system implementing the method 300 obtains a sample of training data. As described above in connection with FIG. 1, in various embodiments, training data includes annotated and/or labeled data suitable for training a machine learning model. Furthermore, in various embodiments, the training data is used during pre-training of an event detection model and/or a generative model. For example, the training data is used to pre-train the generative model to generate labeled training data including one or more labels indicating the location of event triggers.

At block 304, the system implementing the method 300 generates synthetic data. For example, the generative model generates synthetic data suitable for training the event detection model. In various embodiments, the synthetic data includes a set of sentences including words and a set of labels corresponding to the words in the sentences. For example, a sentence of the set of sentences is represented by a first vector (e.g., including words in the sentences) and labels corresponding to words in the sentence are represented by a second vector, where each word has a corresponding label indicating whether the word is an event trigger or not an event trigger.

At block 306, the system implementing the method 300 combines the sampled training data and the synthetic data. In an embodiment, the combined training data and synthetic data are used to train the event detection model. For example, at block 308, the system implementing the method 300 determines the gradient of a loss function based on the combined sampled training data and the synthetic data. In an embodiment, the results of the event detection model are compared to the labels (e.g., ground truth) of the combined sampled training data and the synthetic data to compute the gradient of the loss function. In various embodiments, at block 310, the gradient of the loss function is used to update the parameters of the event detection model.

At block 312, the system implementing the method 300 evaluates the performance of the event detection model on development data. In one example, the development data includes labeled data (e.g., similar to the training data). In various embodiments, similar to above, the gradient of the loss function is computed based on the results of the event detection model performing inferencing on the development data compared to the labels included in the development data. At block 314, the system implementing the method 300 determines a reward value based on the performance of the event detection model. For example, the transpose of the gradient of the loss function representing the performance of the event detection model is multiplied by the gradient of the loss function of the event detection model based on the synthetic data.

At block 316, the system implementing the method 300 determines the gradient of the loss function based on the reward value and the synthetic data. For example, the gradient used to update the parameters of the generative model is computed to include the reward value determined based on the performance of the event detection model. At block 318, the system implementing the method 300 determines whether the number of training epochs has expired. For example, if the number of training epochs has not expired, the system implementing the process 300 returns to block 302 and continues the process 300 until the number of training epochs has been reached. In another example, if the number of training epochs has been reached, the system implementing the process 300 continues to block 320 and provides the trained generative model. In an embodiment, the data generation tool 104 used the trained generative model to generate synthetic data suitable for training various machine learning models.

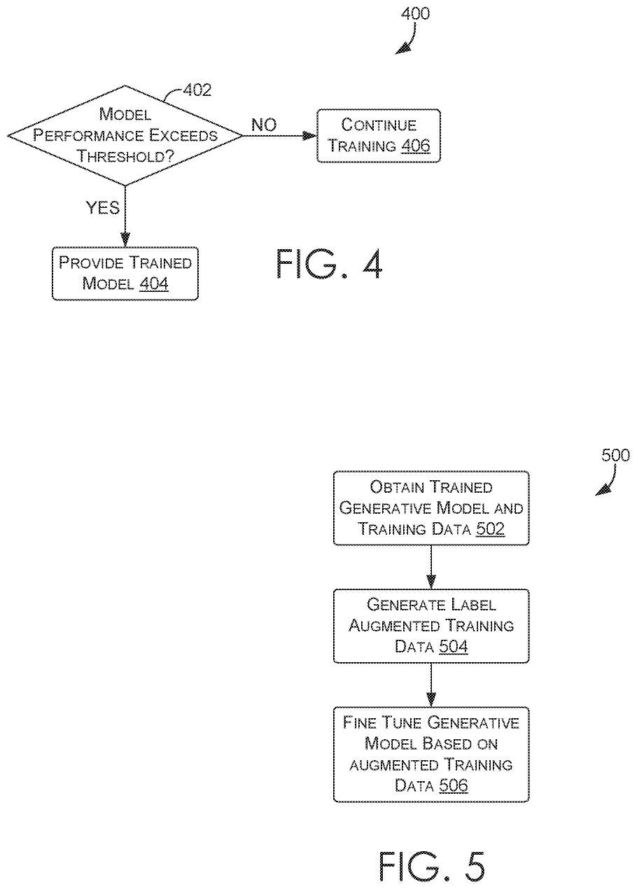

FIG. 4 is a flow diagram showing a method 400 for determining early stopping criteria for training a generative model in accordance with at least one embodiment. The method 400 can be performed, for instance, by the data generation tool 104 of FIG. 1. At block 402, the system implementing the method 400 determines whether model performance exceeds a threshold. For example, as described above, once an event detection model is trained using a combination of training data and synthetic data, the resulting event detection model is evaluated using a development dataset. In various embodiments, a gradient of a loss function is computed to indicate the performance of the event detection model.

In addition, in such embodiments, if the gradient satisfies a threshold, the system implementing the method 400 continues to block 404 and provides the trained model. For example, if the gradient satisfies the threshold, the model is sufficiently trained and the training process can be terminated (e.g., before a number of training iterations is complete). In other embodiments, if the gradient does not satisfy the threshold, the system implementing the method 400 continues to block 406 and the model continues training. For example, the model can be trained using the method 300 described above in connection with FIG. 3.

FIG. 5 is a flow diagram showing a method 500 for pre-training a generative model in accordance with at least one embodiment. The method 500 can be performed, for instance, by the data generation tool 104 of FIG. 1. At block 502, the system implementing the method 500 obtains a trained generative model and training data. For example, the generative model is trained using the training data to generate synthetic data similar to the training data. The training data, in various embodiments, includes annotated and/or label data suitable for training machine learning models.

At block 504, the system implementing the method 500 generates label augmented training data. For example, additional labels and/or tokens are inserted into the training data to indicate trigger words within the training data. In one example, the training data is modified to include labels (e.g., <TRG> and </TRG>) which indicate an event within the training data. Furthermore, in such an example, the pre-training task trains the generative model to place the labels around the events (e.g., trigger words) within the synthetic data. In particular, at block 506, the system implementing the method 506 fine-tunes the generative model based on the label augmented training data. For example, the generative model is trained to place labels around the trigger words (e.g., events to be detected by an event detection model during training).

Having described embodiments of the present invention, FIG. 6 provides an example of a computing device in which embodiments of the present invention may be employed. Computing device 600 includes bus 610 that directly or indirectly couples the following devices: memory 612, one or more processors 614, one or more presentation components 616, input/output (I/O) ports 618, input/output components 620, and illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 6 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 612 includes computer storage media in the form of volatile and/or nonvolatile memory. As depicted, memory 612 includes instructions 624. Instructions 624, when executed by processor(s) 614 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 600. Computing device 600 may be equipped with depth cameras, such as stereoscopic camera systems, infrared camera systems, RGB camera systems, and combinations of these, for gesture detection and recognition. Additionally, computing device 600 may be equipped with accelerometers or gyroscopes that enable detection of motion. The output of the accelerometers or gyroscopes may be provided to the display of computing device 600 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A method comprising:
obtaining a first set of training data for training an event detection model, the first set training data including labeled data;
causing a generative model to generate a second set of training data including labels generated by the generative model;
training the event detection model based on the first set of training data and the second set of training data;
determining a reward value based on a result generated by the event detection model using a third set of training data and a gradient of a loss function based on the second set of training data; and
updating a parameter of the generative model based on the reward value.

2. The method of claim 1, wherein the result indicates performance of the event detection model in detecting events within the third set of training data.

3. The method of claim 1, wherein the first set of training data is sampled from human labeled training data.

4. The method of claim 1, wherein the reward value indicates a similarity between the gradient of the loss function and a second gradient of the loss function based on the third set of training data.

5. The method of claim 4, wherein the loss function further comprises a cosine similarity.

6. The method of claim 1, wherein the method further comprises causing the event detection model to perform an event detection task.

7. The method of claim 1, wherein the event detection model is included in an information extraction pipeline.

8. A non-transitory computer-readable medium storing executable instructions embodied thereon, which, when executed by a processing device, cause the processing device to perform operations comprising:
obtaining a first set of labeled sequences for training an event detection model;
causing a generative model to generate a second set of labeled sequences;
training the event detection model based on the first set of labeled sequences and the second set of labeled sequences by at least updating parameters of the event detection model based on a first gradient of a loss function based on the first set of labeled sequences and the second set of labeled sequences to generate an updated event detection model;
determining a set of reward values corresponding to labeled sequences of the second set of labeled sequences, reward values of the set of reward values determined based on a result of the updated event detection model and a second gradient of the loss function based on the second set of labeled sequences; and
updating parameters of the generative model based on the set of reward values.

9. The medium of claim 8, wherein the result of the updated event detection model is generated based on a third set of labeled sequences.

10. The medium of claim 8, wherein updating the parameters of the generative model based on the set of reward values further includes determining a third gradient of a second loss function based on the set of reward values and a set of labels of the second set of labeled sequences, labels of the set of labels generated by the generative model and indicate an event trigger within the labeled sequences of the second set of labeled sequences.

11. The medium of claim 8, wherein the result of the updated event detection model is generated based on a third set of labeled sequences.

12. The medium of claim 11, wherein the result indicate performance of the updated event detection model to detect events within the third set of labeled sequences.

13. The medium of claim 8, wherein the first set of labeled sequences are sampled from a set of labeled training data.

14. The medium of claim 8, wherein the event detection model is included in an information extraction system.

15. The medium of claim 8, wherein a labeled sequence of the first set of labeled sequences includes a first vector indicating words in the labeled sequence and a second vector indication labels associated with the words.

16. A system comprising:
a memory component; and
a processing device coupled to the memory component, the processing device to perform operations comprising:
obtaining a first set of labeled sequences from an annotated dataset;
causing a generative model to generate a second set of labeled sequences;
generating a training dataset by at least combining the first set of labeled sequences and the second set of labeled sequences;
training an event detection model based on the training dataset by at least updating parameters of the event detection model to generate an updated event detection model;
determining a reward value corresponding to the second set of labeled sequences based on a result of the updated event detection model and a gradient of the loss function based on the second set of labeled sequences; and
updating parameters of the generative model based on the reward value.

17. The system of claim 16, wherein the processing device to perform the operations comprising pre-training the generative model based on the annotated dataset.

18. The system of claim 16, wherein the result of the updated event detection model includes a second gradient of the loss function based on a third set of labeled sequences.

19. The system of claim 18, wherein the second gradient indicates a performance of the updated event detection model to detect a set of event triggers within the third set of labeled sequences.

20. The system of claim 19, wherein the reward value indicates a similarity between the gradient of the loss function based on the second set of labeled sequences and the second gradient of the loss function based on the third set of labeled sequences.
